(19) United States
(12) Patent Application Publication
(10) Pub. No.: US 2026/0170121 A1
(43) Pub. Date: Jun. 18, 2026

(54) METHODS AND SYSTEMS FOR AUTHENTICATION WITHIN A STORAGE DEVICE

(71) Applicant: SK Hynix NAND Product Solutions Corp. (dba Solidigm), Rancho Cordova, CA (US)

(72) Inventor: Gamil CAIN, El Dorado Hills, CA (US)

(21) Appl. No.: 18/984,740

(22) Filed: Dec. 17, 2024

(51) Int. Cl. G06F 21/44

(52) U.S. Cl. CPC G06F 21/44

(57) ABSTRACT

An example method of authentication is performed at a memory device that comprises non-volatile memory and control circuitry. The method includes receiving a data request that includes a set of data and a reference digest and generating an authentication digest for the set of data. The method also includes determining whether the reference digest matches the authentication digest. In accordance with a determination that the reference digest matches the authentication digest, performing an operation corresponding to the data request in the non-volatile memory. In accordance with a determination that the reference digest does not match the authentication digest, indicating that the data request is not to be performed.

### TECHNICAL FIELD

This application relates generally to data storage devices, including but not limited to methods, systems, and devices for authenticating input/output (I/O) communications within data storage devices.

### BACKGROUND

Data authentication (verifying the origin and integrity of data) is an important focus of the computing industry (e.g., data storage and transport). For example, administrators want to ensure that their datacenters are receiving, storing, and operating on legitimate data. For artificial intelligence (AI) applications, it is essential that the AI use authentic data (e.g., be trained, tested, and operated with authentic data).

Confidential computing, trusted execution environments (TEEs), and other related underlying technologies are all attempts to improve data authentication. However, all these technologies impose a significant retrofit of existing compute environments from both a host and storage perspective, such as requiring specific host CPUs with isolation technologies, and hosting new infrastructure for managing cryptographic keys (e.g., Key Management Interoperability Protocol (KMIP) servers). For some environments and users, the cost associated with these infrastructure changes may be a significant burden. Additionally, some of these approaches do not provide data authentication at the data storage devices.

### SUMMARY

The present disclosure describes, amongst other things, a lighter weight approach for ensuring legitimate data is written to and read from a data storage device, without the overhead of a significant retrofit of current infrastructure. The disclosed embodiments include a lightweight method for authenticated I/O between a host and a data storage device, such that the data storage device only accepts I/O communications if/when the data storage device is able to validate the issuer of the I/O communication.

In one aspect, a method of authentication is performed at a data storage device (also sometimes referred to as a memory device) that comprises non-volatile memory and control circuitry. The method includes: (i) receiving a data request that includes a set of data and a reference digest; (ii) generating an authentication digest for the set of data; (iii) determining whether the reference digest matches the authentication digest; (iv) in accordance with a determination that the reference digest matches the authentication digest, performing an operation corresponding to the data request in the non-volatile memory; and (v) in accordance with a determination that the reference digest does not match the authentication digest, indicating that the data request is not to be performed. In some embodiments, the data request also includes a key identifier, and the authentication digest is generated using a key identified by the key identifier.

In accordance with some embodiments, a memory device is provided. The memory device includes control circuitry and memory storing one or more sets of instructions. The one or more sets of instructions include instructions for performing any of the methods described herein.

In accordance with some embodiments, a non-transitory computer-readable storage medium is provided. The non-transitory computer-readable storage medium stores one or more sets of instructions for execution by a memory device (or other type of computing system). The one or more sets of instructions include instructions for performing any of the methods described herein.

Thus, devices and systems are disclosed with methods for authenticating I/O communications. Such methods, devices, and systems may complement or replace conventional methods, devices, and systems for authenticating I/O communications.

The features and advantages described in the specification are not necessarily all inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example system module in an example electronic device in accordance with some embodiments.

FIG. 2 is a block diagram illustrating a storage system of an example electronic device having one or more memory access queues in accordance with some embodiments.

FIG. 3 is a block diagram of an example computing system that includes a storage system having an internal processing capability in accordance with some embodiments.

FIG. 4 is a block diagram illustrating an example computing system including a storage system that operates in compliance with a storage access and transport protocol in accordance with some embodiments.

FIG. 5A is a block diagram illustrating an example computing system that includes a host and a storage device in accordance with some embodiments.

FIG. 5B is flow diagram illustrating an example data authentication process within the example computing system of FIG. 5A in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes means of authenticating data requests (e.g., read and write requests) received at a data storage device. For example, a memory device may receive a data request (e.g., from a host) that includes a set of data, a reference digest, and indication of a shared key. The memory device can generate an authentication digest for the set of data using the shared key, and determine whether the reference digest matches the authentication digest. When the reference digest matches the authentication digest, the memory device can perform an operation corresponding to the data request in non-volatile memory. When the reference digest does not match the authentication digest, the memory device can indicate (e.g., to the host) that the data request is not to be performed. Performing the authentication at the memory device can simplify the authentication method (e.g., reducing the time/cost to retrofit existing compute environments). The authentication process at the memory device prevents malicious entities (e.g., that don’t have access to the shared key) from performing memory operations (e.g., read and write operations) within the memory device, thereby improving the security and integrity of data within the memory device.

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

Memory is used in a computing system to store instructions and data. The data can be processed by one or more processors of the computing system according to the instructions stored in the memory. Multiple memory units may be used in different portions of the computing system to serve different functions. Specifically, the computing system may include non-volatile memory that acts as secondary memory to keep data stored thereon if the computing system is decoupled from a power source or powered down. Examples of secondary memory include, but are not limited to, hard disk drives (HDDs) and solid-state drives (SSDs). Secondary memory relies on a memory controller to manage its memory space and process read, write, and read-modify-write requests from a host device efficiently with low latency. In some embodiments, a memory device (also called a storage device or data storage device) includes a plurality of processing cores, and is transformed to a computational storage device (CSD) by configuring two subsets of processing cores to a memory controller and a data processor, respectively. The data processor is configured to process internal computational storage operations (e.g., data processing operations) locally on the memory device, while the memory controller of the memory device specializes in performing generic storage functions including memory access functions (e.g., I/O access operations) and internal memory management functions.

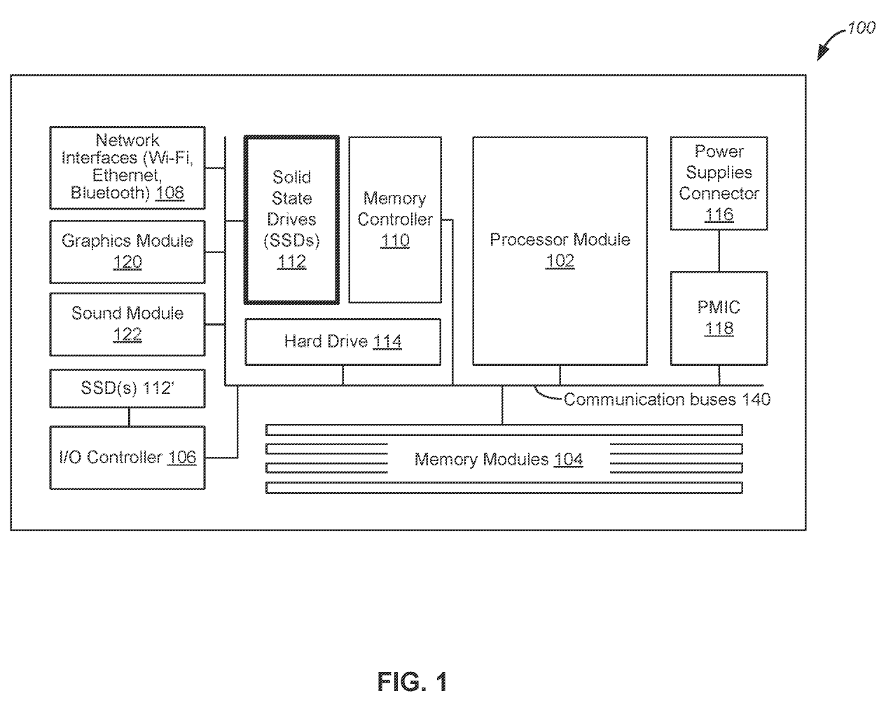

FIG. 1 is a block diagram of an example system module 100 in an electronic system in accordance with some embodiments. The system module 100 includes a processor module 102, memory modules 104 for storing programs, instructions and data, an I/O controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet, and Bluetooth networks, each allowing the electronic system to exchange data with an external source, e.g., a server or another electronic system. In some embodiments, the communication buses 140 include circuitry (sometimes called a chipset) that interconnects and controls communications among various system components included in the system module 100.

In some embodiments, the electronic system comprises a server system, a personal computer, a portable device (e.g., a smartphone, tablet, or laptop), a wearable device, a video conferencing device, and/or other type of electronic device. In some embodiments, the electronic system is, or includes, a host system. In some embodiments, the electronic system is a component of a computing system (e.g., that includes multiple electronic devices).

In some embodiments, the memory modules 104 include high-speed random-access memory, such as static random-access memory (SRAM), double data rate (DDR) dynamic random-access memory (DRAM), and/or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer-readable storage medium. In some embodiments, memory slots are reserved on the system module 100 for receiving the memory modules 104. Once inserted into the memory slots, the memory modules 104 are integrated into the system module 100.

In accordance with some embodiments, the system module 100 further includes one or more of: a storage controller 110, SSD(s) 112, HDD(s) 114, a power management integrated circuit (PMIC) 118, a graphics module 120, and a sound module 122. The storage controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically couplable to an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively, or additionally, in some embodiments, the system module 100 further includes SSD(s) 112΄ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112΄, and HDD 114. These new non-transitory computer readable storage media include, but are not limited to, those manufactured from biological materials, nanowires, carbon nanotubes and individual molecules, even though the respective data storage technologies are currently under development and yet to be commercialized.

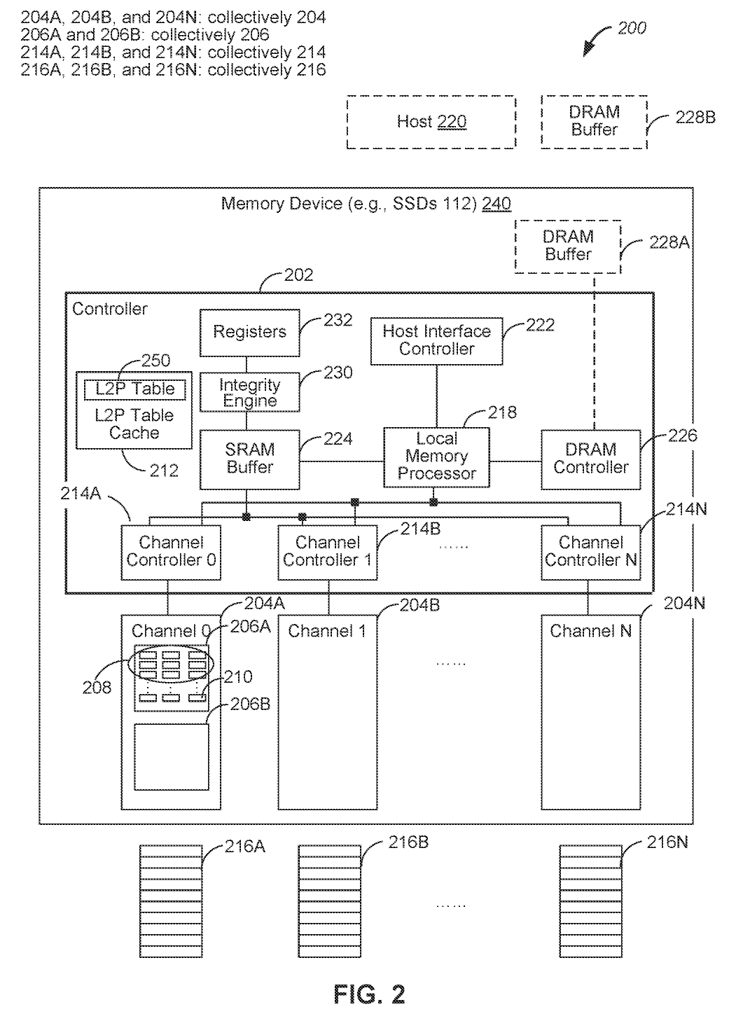

FIG. 2 is a block diagram of a storage system 200 of an example electronic device having one or more memory access queues, in accordance with some embodiments. The storage system 200 is coupled to a host device 220 (e.g., a processor module 102 in FIG. 1) and configured to store instructions and data, e.g., for an extended time, such as when the electronic device sleeps, hibernates, or is shut down. The host device 220 is configured to access the instructions and data stored in the storage system 200 and process the instructions and data, e.g., to run an operating system (OS) and execute user applications. The storage system 200 includes one or more storage devices 240 (e.g., an SSD). In the example of FIG. 2, each storage device 240 further includes a controller 202 and a plurality of memory channels 204 (e.g., channel 204A, 204B, and 204N). Each memory channel 204 includes a plurality of memory cells. The controller 202 may be configured to execute firmware-level software to bridge the plurality of memory channels 204 to the host device 220. In some embodiments, each storage device 240 is formed on a printed circuit board (PCB).

Each memory channel 204 includes one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the storage device 240 includes a plurality of superblocks. Each superblock includes a plurality of memory blocks, each of which further includes a plurality of memory pages 210. For each superblock, the plurality of memory blocks may be configured to be written into and read from the storage system via a memory I/O interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, and each memory block is: (i) distributed on a distinct one of the plurality of memory dies 206 that includes a plurality of pages, (ii) has the same die, plane, and block designations, and (iii) is accessed via a distinct channel of the distinct memory die 206. The storage device 240 may store information of an ordered list of superblocks in a cache of the storage device 240. In some embodiments, the cache is managed by a host driver of the host device 220, and called a host managed cache (HMC).

In some embodiments, the storage device 240 includes a single-level cell (SLC) NAND flash memory chip, and each memory cell stores a single data bit. In some embodiments, the storage device 240 includes a multi-level cell (MLC) NAND flash memory chip, and each memory cell of the MLC NAND flash memory chip stores 2 or more data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips generally operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the storage device 240 corresponds to a single queue 216 of memory access requests. Each memory access request is optionally received internally from the storage device 240 to manage the respective memory channel 204 or externally from the host device 220 to write or read data stored in the respective channel 204. Specifically, each memory access request may include one of: a system write request that is received from the storage device 240 to write to the respective memory channel 204, a system read request that is received from the storage device 240 to read from the respective memory channel 204, a host write request that originates from the host device 220 to write to the respective memory channel 204, and a host read request that is received from the host device 220 to read from the respective memory channel 204. System read requests (also called background read requests or non-host read requests) and system write requests may be dispatched by a storage controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective I/O access operation. Alternatively, in some embodiments, each of a system read request, a system write request, a host write request, and a host read request corresponds to a respective I/O access operation.

In some embodiments, in addition to the channel controllers 214, the controller 202 further includes a local memory processor 218, a host interface controller 222, an SRAM buffer 224, and/or a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks is written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in storage device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n – k) corresponds to integrity data of the user data, where k and n are positive integers. In some embodiments, the storage device 240 includes an integrity engine 230 (e.g., an LDPC engine) and registers 232, which may include a plurality of registers, SRAM cells, and/or flip-flops and are coupled to the integrity engine 230. The integrity engine 230 is coupled to the memory channels 204 via the channel controllers 214 and SRAM buffer 224. In some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the storage system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. In some embodiments, the storage system 200 includes a DRAM buffer 228A, and the L2P address indirection table 250 is stored in the DRAM buffer 228A. The local memory processor 218 of the controller 202 accesses the DRAM buffer 228A via a DRAM controller 226.

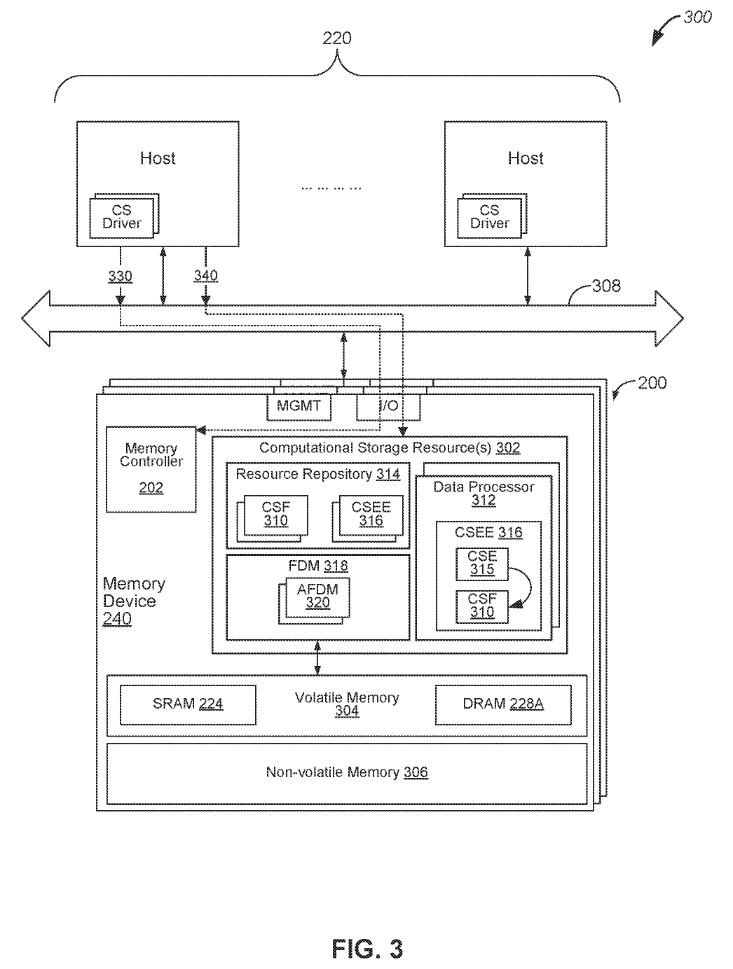

In some embodiments, a memory device 240 includes a plurality of processing cores, and is transformed to a CSD by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., I/O access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

FIG. 3 is a block diagram of a computing system 300 that includes a storage system 200 having an internal processing capability, in accordance with some embodiments. The storage system 200 is also sometimes called a CSD, and includes one or more storage devices 240 (e.g., SSDs). Each storage device 240 further includes a storage controller 202, a volatile memory 304, and a non-volatile memory 306 (e.g., memory channels 204). The host device(s) 220 and the one or more storage devices 240 of the storage system 200 may be coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The storage controller 202 accesses the non-volatile memory 306 in response to the memory access operations. Additionally, in some embodiments, the storage controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each storage device 240 further includes one or more of a L2P table cache 212, an SRAM buffer 224, and a DRAM buffer 228A, and is configured to store data temporarily while the storage controller 202 accesses the non-volatile memory 306 for memory accesses or internal memory management.

In some embodiments, the storage controller 202 is dedicated to processing the memory access requests and internal memory management functions. A storage device 240 further includes one or more computational storage resources (CSRs) 302 configured to implement data processing operations locally on the storage device 240. A set of predefined data processing operations are implemented to perform a computational storage function (CSF) 310, which is distinct from the memory access and internal memory management functions performed by the storage controller 202. In some embodiments, a computational storage resource 302 processes user data that is received from the host device(s) 220 or extracted from the non-volatile memory 306 during the data processing operations. In some embodiments, the processed data is stored into the non-volatile memory 306 or sent to the host device(s) 220 via the fabric 308. Further, in some embodiments, a subset of the user data, the process data, and/or intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the storage device 240. The resource repository 314 may be a centralized location (e.g., memory space) that stores various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that is used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 220 issues a memory read or write request 330 to a storage device 240 of the storage system 200, and the storage controller 202 of the storage device 240 receives the memory read or write request 330 and accesses the non-volatile memory 306 accordingly. In some embodiments, a host device 220 issues a data processing request 340 to the storage device 240, and a data processor 312 of the computational storage resource 302 (e.g., the computational storage engine 315) receives the data processing request 340 and processes user data extracted from the data processing request or the non-volatile memory 306.

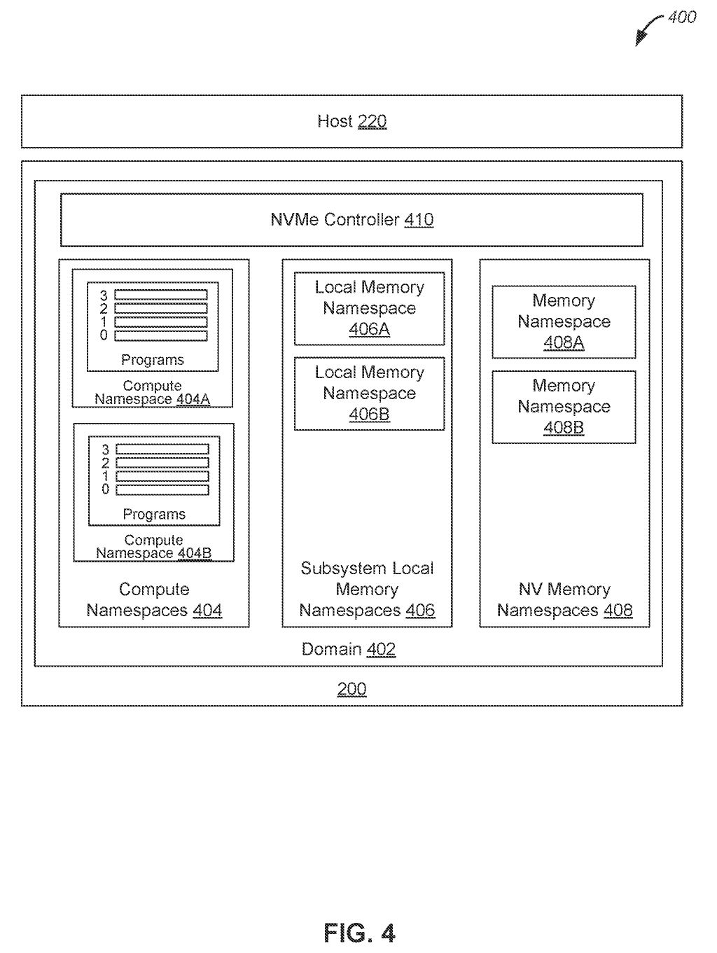

FIG. 4 is a block diagram of a computing system 400 that includes a storage system 200 that operates in compliance with a storage access and transport protocol (e.g., nonvolatile memory express (NVMe)), in accordance with some embodiments. The storage system 200 includes one or more storage devices 240 each of which corresponds to a domain 402 according to the storage access and transport protocol. Each domain 402 corresponding to a respective storage device 240 includes a one or more compute namespace 404, local memory namespaces 406, memory namespaces 408, and a domain controller 410. Each namespace is a collection of LBAs accessible to, or associated with, a respective one of the plurality of programs.

In accordance with some embodiments, a storage device 240 includes one or more processors having a computation capability (e.g., a storage controller 202, a data processor 312), a volatile memory 304 (e.g., a cache 212, an SRAM buffer 224, a DRAM buffer 228A), and a non-volatile memory 306. When the storage device 240 executes a plurality of programs, resources of the storage controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the storage device 240. Resources of the volatile memory 304 are allocated based on a plurality of local memory namespaces 406 (e.g., 406A and 406B) to facilitate execution of the plurality of programs by the storage device 240, so are resources of the non-volatile memory 306 allocated based on a plurality of memory namespaces 408 (e.g., 408A and 408B). In some embodiments, the number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the storage device 240. In some situations, input data that is processed, and output data that is generated, by these instructions is temporarily stored based on the local memory namespace 406A. In some situations, the input data is extracted based on the non-volatile memory namespace 408A, and the output data is stored based on the non-volatile memory namespace 408A. By these means, namespace allocation and utilization in the domain 402 corresponding to the storage device 240 is managed according to the storage access and transport protocol.

In some embodiments, the storage access and transport protocol includes an NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each storage device 240 (e.g., SSD) as a standard NVMe storage device using the NVMe protocol. The host device 220 is configured to read and write data and implement data processing operations on the storage device 240 using NVMe commands.

In some embodiments, the host device 220 uses an operating system (e.g., a Linux operating system), and the CSRs 302 (FIG. 3) of the storage device 240 use an embedded operating system (e.g., an embedded Linux operating system) that matches the operating system of the host device 220. In some embodiments, the host device 220 uses extended vendor unique commands to control and interact with the embedded operating system of the CSRs 302 of the storage device 240.

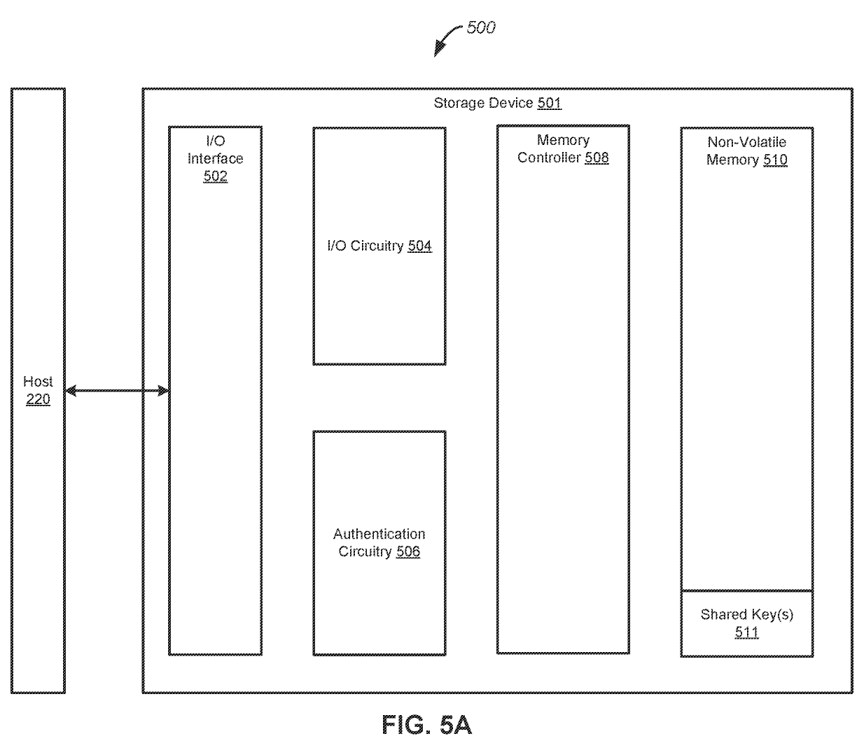

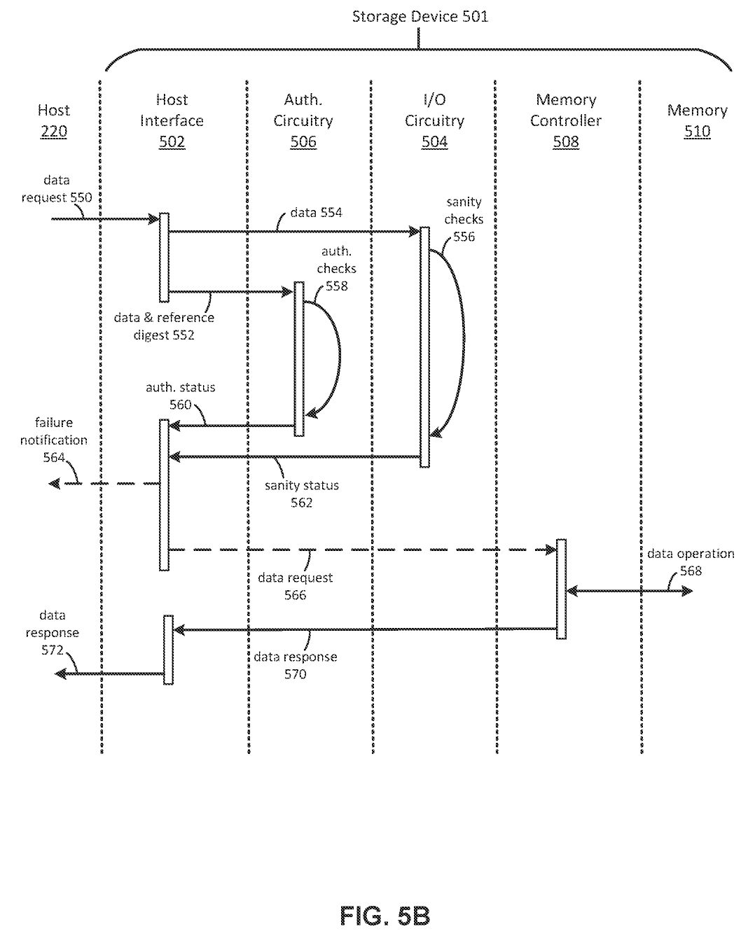

FIG. 5A is a block diagram illustrating a computing system 500 (e.g., an electronic system) that includes a host 220 and a storage device 501 in accordance with some embodiments. In the example of FIG. 5A, the storage device 501 includes an I/O interface 502, I/O circuitry 504, authentication circuitry 506, a memory controller 508, and non-volatile memory 510. In some embodiments, the storage device 501 includes a superset or subset of the components shown in FIG. 5A.

In FIG. 5A, the storage device 501 is communicatively coupled to the host 220 via the I/O interface 502 (e.g., and a communication fabric or bus). The I/O interface 502 is sometimes referred to as a host interface. The I/O interface 502 corresponds to a connection point that allows data to be transferred between the host 220 and the storage device 501. In some embodiments, the I/O interface 502 is configured to convert data received in a transport protocol to a different protocol used by components of the storage device 501. For example, the I/O interface 502 may unwrap data packets received from the host 220. In some embodiments, the I/O interface 502 is configured to route data received from the host 220 to appropriate components of the storage device 501 (e.g., the I/O circuitry 504, the authentication circuitry 506, and/or the memory controller 508).

The I/O circuitry 504 may comprise one or more processors, microprocessors, and/or other types of circuitry. In some embodiments, the I/O circuitry 504 includes a set of instructions (e.g., in firmware and/or software). In some embodiments, the I/O circuitry 504 is configured to perform one or more sanity checks. In some embodiments, the one or more sanity checks include one or more I/O checks (e.g., checking whether a logical address for the data is valid). In some embodiments, the checks include checking an address mapping for the address. In some embodiments, the checks includes determining whether the data request complies with one or more memory access requirements. In some embodiments, the checks include a protection information (PI) check. In some embodiments, the checks include a data integrity check, such as a cyclic redundancy check (CRC). In some embodiments, the I/O circuitry 504 determines whether a data packet is valid based on the sanity check(s). For example, if the sanity check(s) each indicate that the packet is valid then the I/O circuitry 504 determines that the packet is valid, and a corresponding operation may be performed by the storage device 501. If one of the sanity check(s) indicates that the packet is invalid then the I/O circuitry 504 determines that the packet is invalid (e.g., and generates a failure notification to be sent to the host 220).

The authentication circuitry 506 may comprise one or more processors, microprocessors, and/or other types of circuitry. In some embodiments, the authentication circuitry 506 includes a set of instructions (e.g., in firmware and/or software). In some embodiments, the authentication circuitry 506 comprises a dedicated processing unit. In some embodiments, the authentication circuitry 506 is configured to verify digests. In some embodiments, the authentication circuitry 506 is separate and distinct from the I/O circuitry 504. In some embodiments, the authentication circuitry 506 corresponds to a first processor core and the I/O circuitry 504 corresponds to a second core of the same processor (e.g., the data processor 312). In some embodiments, a same circuit (or set of circuits) is used to in place of the I/O circuitry 504 and the authentication circuitry 506. In some embodiments, the authentication circuitry 506 is an extension of the I/O circuitry 504. For example, the I/O and authentication may be processed serially or in parallel within the same processing unit.

In some embodiments, the authentication circuitry 506 is configured to generate a digest (e.g., a keyed hash, such as a hash-based message authentication code (HMAC)) of an incoming data packet based on a key (e.g., a key identified using an identifier associated with the data packet). In some embodiments, the authentication circuitry 506 is configured to compare the generated digest with a digest received with the data packet. In some embodiments, the authentication circuitry 506 determines whether a data packet is authenticated based on a comparison between a generated digest and a digest received with the data packet. For example, if the digests match then the authentication circuitry 506 indicates that the data packet is authenticated, and a corresponding operation may be performed by the storage device 501. If the digests do not match, then the authentication circuitry 506 indicates that the data packet is invalid (e.g., and generates a failure notification to be sent to the host 220).

In some embodiments, the authentication circuitry 506, in accordance with detecting an authentication failure (e.g., a failed match), generates an entry into an internal log page, e.g., which can be retrieved later by a host. In some embodiments, the authentication circuitry 506 generates the log entry instead of generating the failure notification. In this way, the storage device 501 may operate in a honey pot mode in which it logs failures without alerting the user. For example, the storage device 501 may forgo performing the memory operations, log the failures, but not generate the failure notifications. In some embodiments, in accordance with detecting an authentication failure, the authentication circuitry 506 provides an out-of-band signal of the failure (e.g., instead of providing the failure via the host interface). Providing an out-of-band notification (e.g., to a baseboard management controller) can improve security by providing the notification to an administrator or other party (e.g., in addition to, or rather than, providing a notification to the unauthenticated user). In some embodiments, the authentication circuitry 506 logs any failed authentications and provides corresponding notices via an OOB notification.

In some embodiments, the memory controller 508 is an instance of the memory controller 202 described previously. In some embodiments, the memory controller 508 governs operations performed at the non-volatile memory 510. In some embodiments, the memory controller 508 is configured to perform storage functions, including memory access functions (e.g., I/O access operations), and internal memory management functions. In some embodiments, the non-volatile memory 510 is an instance of the non-volatile memory 306 described previously. In accordance with some embodiments, the non-volatile memory 510 stores one or more shared keys 511. In some embodiments, the shared key(s) 511 are received from an authenticated host. In some embodiments, the shared key(s) 511 are received during a provisioning of the storage device 501. For example, the shared keys may be provisioned in a secure environment and stored security at the storage device and the host (e.g., to prevent an unauthorized user from gaining access to the keys). In some embodiments, the shared key(s) 511 are stored in a different location on the storage device 501.

FIG. 5B is flow diagram illustrating an example data authentication process within the example computing system of FIG. 5A in accordance with some embodiments. As shown in FIG. 5B, the host 220 may transmit a data request 550 to the storage device 501. In some embodiments, the data request 550 comprises a data packet, e.g., an I/O packet. In some embodiments, the data packet comprises a request to write data to the memory 510 or a request to read data from the memory 510. In some embodiments, the data request 550 comprises a data packet and a packet digest (e.g., the packet digest being generated by the host 220). In some embodiments, the data request 550 comprises a data packet, a packet digest, and a key identifier that identifies the key that was used to generate the packet digest. In some embodiments, the packet digest comprises a keyed hash of the data packet.

In accordance with some embodiments, the data request 550 is received at the host interface 502. In accordance with receiving the data request 550, the host interface 502 transmits data 554 to the I/O circuitry 504. For example, the host interface 502 sends the data packet to the I/O circuitry 504. In some embodiments, the host interface 502 transmits the data 554 to the I/O circuitry 504 in response to receiving the data request 550. In some embodiments, the data 554 comprises an I/O packet. In some embodiments, the data 554 comprises all of the data request 550. In accordance with receiving the data 554, the I/O circuitry 504 performs one or more sanity checks 556. In some embodiments, the I/O circuitry 504 performs one or more sanity checks 556 in response to receiving the data 554.

In accordance with receiving the data request 550, the host interface 502 transmits data and reference digest 552 to the authentication circuitry 506. In some embodiments, the host interface 502 transmits data and reference digest 552 to the authentication circuitry 506 in response to receiving the data request 550. In some embodiments, the data and reference digest 552 comprises at least a portion of the data request 550. In accordance with receiving the data and reference digest 552, the authentication circuitry 506 performs one or more authentication checks 558. In some embodiments, the authentication circuitry 506 performs one or more authentication checks 558 in response to receiving the data and reference digest 552. For example, the authentication circuitry 506 generates a digest for the data using a key (e.g., a key identified in the data request 550) and compares the generated digest to the reference digest.

The authentication circuitry 506 transmits an authentication status 560 indicating whether the data from the data request 550 is authenticated (e.g., whether the generated digest matches the reference digest). The I/O circuitry 504 transmits a sanity status 562 indicating whether the data 554 is valid (e.g., whether the data passed each of the sanity checks).

In some embodiments, in accordance with at least one of the authentication status 560 and the sanity status 562 indicating a failure, the host interface 502 generates a failure notification 564 and transmits the failure notification 564 to the host 220. In some embodiments, the failure notification 564 indicates that the authentication check(s) 558 and/or the sanity check(s) 556 failed. For example, a first type of failure notification 564 is generated when the authentication check(s) 558 indicate that the data request 550 is unauthorized. As another example, a second type of failure notification 564 is generated when the sanity check(s) 556 indicate that the data request 550 is invalid. As another example, a third type of failure notification 564 is generated when the sanity check(s) 556 indicate that the data request 550 is invalid and the authentication check(s) 558 indicate that the data request 550 is unauthorized.

In some embodiments, in accordance with each of the authentication status 560 and the sanity status 562 indicating a success, the host interface 502 allows a data operation 568 to be performed for the data request 550. In some embodiments, the host interface 502 transmits the data request 566 to the memory controller 508 and the memory controller 508 causes the data operation 568 to be performed. In some embodiments, the memory controller 508 causes the data operation 568 to be performed in response to receiving the authentication status 560 and the sanity status 562, each indicating a success. For example, the memory controller 508 may receive the statuses 560 and 562 from the authentication circuitry 506 and the I/O circuitry 504. In some embodiments, the memory controller 508 receives a data request 566 that corresponds to the data request 550. In some embodiments, the memory controller 508 generates the data operation 568 based on the data request 566. The data operation 568 may comprise a read operation, a write operation, or other type of memory operation.

In some embodiments, the memory controller 508 transmits a data response 570 that indicates an outcome of the data operation 568. In some embodiments, the memory controller 508 generates the data response 570 in response to the data operation 568 being completed. In accordance with some embodiments, the data response is transmitted to the host interface 502. In some embodiments, the host interface 502 generates a data response 572 based on the data response 570. In some embodiments, the data response 572 comprises the data response 570. In some embodiments, the data response 572 comprises the data response 570 converted to a different protocol (e.g., a transport or communication protocol).

In some embodiments, the storage device 501 includes a different arrangement of components than shown in FIG. 5A. In some embodiments, the I/O circuitry 504 governs the data operation 568 instead of the memory controller 508. For example, the storage device 501 may not include a separate memory controller 508 and instead relies on the I/O circuitry 504 to provide the functionality of the memory controller 508. In some embodiments, the authentication circuitry 506 provides the authentication status 560 to the I/O circuitry 504 and the I/O circuitry 504 generates the failure notification 564 or the data operation 568 as appropriate. In some embodiments, the I/O circuitry 504 provides the sanity status 562 to the authentication circuitry 506. In some embodiments, the authentication circuitry 506 causes the failure notification 564 to be generated or the data operation 568 to be performed, as appropriate.

As an example, a host (e.g., the host 220) generates an I/O packet (e.g., corresponding to the data 554) and a digest of the I/O packet (e.g., an HMAC digest). The digest is generated using a shared key. The host generates an I/O command that includes the I/O packet and the digest. The I/O command may also include an indicator for the shared key. For example, the host may choose to generate multiple shared keys and provision them in the storage device and then send a key identifier indicating which key to use for the I/O command. The digest and an identifier for the shared key (key_id) may be included in the I/O command to the storage device, e.g., as additional metadata. In addition to normal I/O processing, the storage device may extract the digest (and optionally the key_id) from the incoming I/O and forward it to an I/O authentication processor (e.g., the authentication circuitry 506). While normal I/O processing is occurring, the I/O authentication processor may verify the digest (e.g., in parallel with sanity checking) and generate a corresponding digest verification status. If the digest verification status indicates a failure (or other failures occur during normal I/O processing), a failure status is returned to the host. Otherwise, the I/O command is allowed to complete successfully.

In the following, some example embodiments are described.

(A1) In one aspect, some embodiments include a method of authentication. In some embodiments, the method is performed at a computing system having memory and one or more processors. In some embodiments, the method is performed at a data storage device that comprises non-volatile memory and control circuitry. In some embodiments, the data storage device consists essentially of non-volatile memory and control circuitry. The method includes: (i) receiving a data request (e.g., the data request 550) that includes a set of data and a reference digest; (ii) generating an authentication digest (e.g., at the authentication circuitry 506) for the set of data; (iii) determining whether the reference digest matches the authentication digest; (iv) in accordance with a determination that the reference digest matches the authentication digest, performing an operation (e.g., the data operation 568) corresponding to the data request in the non-volatile memory; and (v) in accordance with a determination that the reference digest does not match the authentication digest, indicating that the data request is not to be performed (e.g., indicating via the failure notification 564). In some embodiments, the set of data comprises a data packet (e.g., an I/O packet). In some embodiments, the reference digest comprises a keyed hash of the set of data. In some embodiments, the reference digest comprises an HMAC digest. In some embodiments, the reference digest is included as metadata for the data request. In some embodiments, the reference digest is generated by the host using a same key as the authentication digest. In some embodiments, the reference digest is generated by the host as part of the process of generating the data request. In some embodiments, the indication that the data request is not to be performed is provided via an OOB notification.

(A2) In some embodiments of A1, the data request further includes a key identifier, and the authentication digest is generated using a key (e.g., one of the shared key(s) 511) identified by the key identifier. For example, the key identifier indicates the key used to generate the reference digest. In some embodiments, the authentication digest is generated by using the key on the data of the data request. In some embodiments, the memory device stores a set of keys and identifies the key from the set of keys using the key identifier. In some embodiments, generating the authentication digest comprises applying the key to the set of data. In some embodiments, the set of keys are stored on the memory device during initialization and/or provisioning. In some embodiments, multiple keys are stored at the storage device and the key identifier indicates which stored key is to be used for the data request. In some embodiments, the multiple keys are stored in a secure memory portion of the non-volatile memory (e.g., that is not accessible by the host device). In some embodiments, different logical block addresses are mapped to different key identifiers. In some embodiments, a key identifier is not included in the data request. In some embodiments, which key to use is determined based on a logical block address indicated in the data request.

(A3) In some embodiments of A1 or A2: (i) the control circuitry comprises an authentication controller and an access controller; and (ii) the authentication controller determines whether the reference digest matches the authentication digest. In some embodiments, the authentication controller comprises an authentication processor. In some embodiments, the access controller comprises an I/O processor. In some embodiments, the control circuitry further comprises a non-volatile memory (NVM) controller. In some embodiments, the control circuitry further comprises a host interface. In some embodiments, the authentication controller determines whether the reference digest matches the authentication digest concurrent with the access controller performing normal I/O processing on the set of data. Performing the authentication process in parallel with the normal I/O processing allows for the authentication to be performed without increasing the access latency associated with the storage device. In some embodiments, the authentication controller is a distinct computing unit from the access controller (e.g., a dedicated processing unit). In some embodiments, the authentication controller and the access controller corresponds to separate CPUs or CPU cores. In some embodiments, the authentication controller and the access controller are defined in firmware and/or software of the memory device.

(A4) In some embodiments of A3, the method further includes, while the authentication controller determines whether the reference digest matches the authentication digest, performing one or more checks on the set of data using the access controller. The one or more checks are sometimes referred to as sanity checks or I/O checks. In some embodiments, the one or more checks include a CRC and/or PI check.

(A5) In some embodiments of A4, the set of data comprises an address, and the one or more checks comprise checking whether the address is valid. In some embodiments, the one or more checks comprise checking an address mapping for the address. In some embodiments, the one or more checks comprise determining whether the data request complies with one or more memory access requirements.

(A6) In some embodiments of any of A1-A5, performing the data request comprises writing a subset of the set of data to the non-volatile memory. For example, the set of data may include addressing data and content data, and the content data is written to the non-volatile memory at a location indicated by the addressing data.

(A7) In some embodiments of any of A1-A6, performing the data request comprises reading from the non-volatile memory. For example, the set of data indicates memory locations to be read from the non-volatile memory.

(A8) In some embodiments of any of A1-A7, the data request is received from a host communicatively coupled to the memory device. In some embodiments, the host generates the reference digest (by applying a user key to the set of data) and appends the reference digest to the set of data (e.g., along with an indication of the user key).

(A9) In some embodiments of any of A1-A8, indicating that the data request is not to be performed comprises generating a failure notification. For example, the data request is sent from a host and the failure notification is returned to the host in response. In some embodiments, a first type of failure notification is generated in accordance with the reference digest not matching the authentication digest, and a second type of failure notification is generated in accordance with a sanity check failure.

(A10) In some embodiments of any of A1-A9, the method further includes receiving one or more shared keys from a host device, and storing the one or more shared keys in memory of the data storage device. In some embodiments, the one or more shared keys are received from the host device in accordance with (e.g., in response to) authentication of the host device (e.g., during a provisioning process). In some embodiments, each shared key corresponds to a respective user at the host device. In some embodiments, each shared key corresponds to a respective portion of the memory of the data storage device. In some embodiments, a shared key of the one or more shared keys is used to generate the authentication digest (e.g., based on a key identifier, and/or address information, for each data request).

In another aspect, some embodiments include a storage device (e.g., storage device 501) including control circuitry (e.g., the authentication circuitry 506, the I/O circuitry 504, and/or the memory controller 508) and memory (e.g., the memory 510) coupled to the control circuitry, the memory storing one or more sets of instructions configured to be executed by the control circuitry, the one or more sets of instructions including instructions for performing any of the methods described herein (e.g., A1-A10 above).

In yet another aspect, some embodiments include a non-transitory computer-readable storage medium storing one or more sets of instructions for execution by control circuitry of a computing system (e.g., the storage device 501), the one or more sets of instructions including instructions for performing any of the methods described herein (e.g., A1-A10 above).

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method of authentication, comprising:
at a memory device that comprises non-volatile memory and control circuitry:
receiving a data request that includes a set of data and a reference digest;
generating an authentication digest for the set of data;
determining whether the reference digest matches the authentication digest;
in accordance with a determination that the reference digest matches the authentication digest, performing an operation corresponding to the data request in the non-volatile memory; and
in accordance with a determination that the reference digest does not match the authentication digest, indicating that the data request is not to be performed.

2. The method of claim 1, wherein the data request further includes a key identifier, and wherein the authentication digest is generated using a key identified by the key identifier.

3. The method of claim 1, wherein:
the control circuitry comprises an authentication controller and an access controller; and
the authentication controller determines whether the reference digest matches the authentication digest.

4. The method of claim 3, further comprising, while the authentication controller determines whether the reference digest matches the authentication digest, performing one or more checks on the set of data using the access controller.

5. The method of claim 4, wherein the set of data comprises an address, and wherein the one or more checks comprise checking whether the address is valid.

6. The method of claim 1, wherein performing the data request comprises writing a subset of the set of data to the non-volatile memory.

7. The method of claim 1, wherein performing the data request comprises reading from the non-volatile memory.

8. The method of claim 1, wherein the data request is received from a host communicatively coupled to the memory device.

9. The method of claim 1, wherein indicating that the data request is not to be performed comprises generating a failure notification.

10. A memory device, comprising:
non-volatile memory; and
control circuitry configured to:
receive a data request that includes a set of data and a reference digest;
generate an authentication digest for the set of data;
determine whether the reference digest matches the authentication digest;
in accordance with a determination that the reference digest matches the authentication digest, perform an operation corresponding to the data request in the non-volatile memory; and
in accordance with a determination that the reference digest does not match the authentication digest, indicate that the data request is not to be performed.

11. The memory device of claim 10, wherein the data request further includes a key identifier, and wherein the authentication digest is generated using a key identified by the key identifier.

12. The memory device of claim 10, wherein:
the control circuitry comprises an authentication controller and an access controller; and
the authentication controller determines whether the reference digest matches the authentication digest.

13. The memory device of claim 12, wherein the access controller is configured to perform one or more checks on the set of data while the authentication controller determines whether the reference digest matches the authentication digest.

14. The memory device of claim 13, wherein the set of data comprises an address, and wherein the one or more checks comprise checking whether the address is valid.

15. The memory device of claim 10, wherein performing the data request comprises writing a subset of the set of data to the non-volatile memory.

16. The memory device of claim 10, wherein performing the data request comprises reading from the non-volatile memory.

17. The memory device of claim 10, wherein the data request is received from a host communicatively coupled to the memory device.

18. The memory device of claim 10, wherein indicating that the data request is not to be performed comprises generating a failure notification.

19. A non-transitory computer-readable storage medium storing instructions, which when executed by a memory device that comprises non-volatile memory, cause the memory device to:
receive a data request that includes a set of data and a reference digest;
generate an authentication digest for the set of data;
determine whether the reference digest matches the authentication digest;
in accordance with a determination that the reference digest matches the authentication digest, perform an operation corresponding to the data request in the non-volatile memory; and
in accordance with a determination that the reference digest does not match the authentication digest, indicate that the data request is not to be performed.

20. The non-transitory computer-readable storage medium of claim 19, wherein the instructions, when executed by the memory device, cause the memory device to perform one or more checks on the set of data concurrently with determining whether the reference digest matches the authentication digest.
